(19) United States
(12) Patent Application Publication
(10) Pub. No.: US 2024/0160408 A1
(43) Pub. Date: May 16, 2024

(54) FILTERING NOISY OBSERVATIONS

(71) Applicant: Five AI Limited, Cambridge (GB)

(72) Inventor: Paul Balanca, Cambridge (GB)

(73) Assignee: Five Al Limited, Cambridge (GB)

(21) Appl. No.: 18/282,475

(22) PCT Filed: Mar. 15, 2022
(86) PCT No.: PCT/EP2022/056757

§ 371 Date: Sep. 15, 2023

(30) Foreign Application Priority Data
Mar. 16, 2021 (GB) 2103633.0

(51) Int. Cl. G06F 7/556; G06N 5/022

(52) U.S. Cl. CPC G06F 7/556; G06N 5/022

(57) ABSTRACT

A computer-implemented method of filtering noisy observations of a system to estimate a state of the system, the method comprising: applying a filter to a sequence of observations based on one or more filter parameters, to compute a set of system states, the filter parameters configurable to change respective contributions of the observations to the set of system states; wherein the filter is applied in multiple iterations with different values of the configurable parameter(s), to update the set of system states, wherein the different values of the configurable filter parameter are determined via a gradient-based optimization of a loss function that penalizes values of the configurable parameters that result in relatively large contributions from outlier observations that deviate from the set of system states by a relatively large amount.

### TECHNICAL FIELD

The present disclosure pertains to methods of filtering noisy observations of a system, and devices and computer programs for implementing the same.

### BACKGROUND

A filter is a component or method that takes a set of observations of a system and estimates a state of the system therefrom (the “ground truth” state). The observations may be incomplete and/or noisy, and the filter attempts to produce a best estimate of the underlying ground truth state of the system, given the noisy/incomplete observations. Examples of such filters include Kalman filters, including unscented and extended Kalman filters, particle filters etc.

Filters have many applications in signal processing and other technical fields. The observations may, for example, be measurements captured using one or more physical sensors, or observations derived from sensor signals using a variety of processes, such as 2D or 3D object detection, localization, pose detection, size estimation, odometry etc. applied to one or multiple sensor modalities, such as image data, lidar, radar, inertial sensor data etc. For example, in the field of autonomous driving, a filter may be applied to observations captured by a sensor-equipped vehicle (the ego vehicle), in order to provide a best estimate of a state of the ego vehicle and/or a state of one or more sensed objects in the ego vehicle's vicinity. For example, filters may be applied to determine trajectories for vehicles or objects of a scene in time, given imperfect or noisy sensor measurements. Such filtering can be applied “online”, in real time, within an autonomous vehicle (AV) perception system, but also in an “offline” context, e.g. to provide functions such as mapping, sensor data annotation (e.g. automatic or semi-automatic annotation of images and other sensor data) and scene extraction (extracting higher-level scene descriptions that allow a scene to be reproduced in simulation). Filters have similar applications in the field of robotics more generally. A filter may also be applied on simulated observations, e.g. within a robotic runtime stack under testing or training. For example, a filter may be deployed in simulation within an AV stack whose performance is tested on simulated driving scenarios.

Certain filters, such as Kalman filters, are configured to receive a series of observations together with an error (uncertainty) estimate for each observation, e.g. in the form of a covariance. Such filters can combine those observations in a way that respects their relative levels of uncertainty, giving more weight to observations with a lower level of error and less weight to observations with a higher level or error. In some cases, this could include observations captured from multiple sources (e.g. different sensors and/or different sensor modalities). A benefit of filtering is the ability to estimate a system state that potentially has a lower level or error than any of the individual observations. The output of the filter may also be probabilistic, in the sense that it defines a distribution over the state (rather than a deterministic estimate). For example, the filter may provide an estimate of the state, together with a covariance, that together define the state distribution.

Kalman filtering considers both estimated and predicted states. For a given time step k, and a sequence of observation (o₁, . . . oₖ) up to step k, a Kalman filter computes an estimate of the state at time k given the observations up to k, denoted x_{k|k} and having covariance P_{k|k}. In the context of conventional Kalman filtering, a “predicted” state means a prediction of the state at some later time k+j based on the estimated system xₖ at time k. For conventional Kalman filtering, the predicted state may be denoted as x_{k+j|k} and its covariance may be denoted as P_{k+j|k}, where the notation reflects the fact that the predicted state x_{k+j|k} at time k+j is derived from the estimated state at time k via some motion model or other state transition model. In conventional Kalman filtering, the state x_{k+j|k} is the predicted state given only the observations up to k (but not any subsequent observations up to k+j). Certain filters, such as Kalman filters, compute an estimated state of a system at time k using only current and historic observations (the observations up to the time k). The term filter/filtering is sometimes used in the art to refer to a state estimation component or method that only used current and historic observations (“forward” filtering). However, the term is used in a broader sense herein, and also applies to components/methods that compute an estimated system state (at some time k) based on future observations (from time k+1 or greater)—so-called “backward” filtering, also referred to as “smoothing” (smoothing being a form of filtering according to the present terminology). Filtering that uses both historic and future observations may be referred to as “forward-backward” filtering. Note also that the terms “predicted” and “forecasted” are used interchangeably herein, and can refer to an earlier state in time that is predicted using some reversible state transition model.

An issue with Kalman filters and similar filtering techniques is their sensitivity to outlier observations and non-Gaussian noise in observations. One way to improve the robustness of Kalman filters to outliers is to apply a gating mechanism which classifies observations as outliers based on a distance measure to the estimated states of the filter projected into the space of the observations. This is a form of outlier rejection applied to Kalman filtering. For example, one technique classes as outliers observations whose Mahalanobis distance to the projected state is above a threshold.

Another possible way of improving the robustness of filtering methods to outliers is to apply a technique known as ‘multi-hypothesis tracking’. The principle of multi-hypothesis tracking is that instead of making an absolute classification of observations as inliers or outliers, each of these classification outcomes is treated as a hypothesis, the progress of the filter is tracked for both hypotheses. That is, two ‘branches’ of the filter are formed, one tracking the predicted states of the system assuming a given observation is an inlier, and another tracking the predicted states assuming the observation is an outlier. As the multi-hypothesis approach is applied to multiple consecutive observations, the branches multiply into a tree structure, each leaf of the tree representing a different combination of hypotheses.

### SUMMARY

The present disclosure pertains generally to improved outlier rejection in the context of Kalman filtering and similar filtering methods. This, in turn, leads to improved robustness in the filtering and provides accurate state estimation in a wider range of contexts.

The present disclosure recognizes that existing gating-based outlier rejection methods are only effective when the filter has stabilised or does not see a rapid change of state. This is because the gating relies on the estimations made by the filter. If a Kalman filter has a rapidly changing state, and a given projected state of the filter is a poor estimate for the actual state of the system, it may cause observations to be misclassified as outliers and discarded from the update, which may cause future estimations of the filter to diverge from the ‘ground truth’ state of the system. Multi-hypothesis tracking techniques may be used to address this problem, as alternative classifications of observations are maintained throughout application of the filter. However, tracking of this tree of hypotheses becomes intractable without pruning the set of hypotheses, which is difficult to do effectively. Described herein is a gradient-based method for learning a weighted update to filter states, where outlying observations are weighted less heavily in updates to the filter state than inlying observations.

A first aspect disclosed herein provides a computer-implemented method of filtering noisy observations of a system to estimate a state of the system, the method comprising: applying a filter to a sequence of observations based on one or more filter parameters, to compute a set of system states, the filter parameters configurable to change respective contributions of the observations to the set of system states; wherein the filter is applied in multiple iterations with different values of the configurable parameter(s), to update the set of system states, wherein the different values of the configurable filter parameter are determined via a gradient-based optimization of a loss function that penalizes values of the configurable parameters that result in relatively large contributions from outlier observations that deviate from the set of system states by a relatively large amount.

The loss function may be defined as a weighted distance measure between the computed system states and the observations, the distance measure weighted in dependence on the filter parameters.

The loss may be defined, for each timestep k of a sequence of timesteps, as lₖ=Σⱼ₌₀^{M}λ_{j,k} d(x_{k+j|k}, oₖ₊ⱼ), in which:
d(x_{k+j|k}, oₖ₊ⱼ) is the distance measure between a predicted system state x_{k+j|k} of the computed system states at timestep k+j and an observation(s) oₖ₊ⱼ of the sequence of observations at timestep k+j, the predicted system state x_{k+j|k} computed by the filter from one or more observations at or prior to, but not later than, timestep k, and
M is a number of lookahead steps greater than or equal to zero;
wherein the predicted system state x_{k+j|k} is computed based on the filter parameters, and λ_{j,k} is a weighting factor that is also dependent on the filter parameters.

Each timestep k may be associated with a filter parameter wₖ of the filter parameters, wherein each predicted system state x_{k+j|k} is computed based on the filter parameter wₖ, and λ_{j,k} is dependent on a subset of the filter parameters {wᵢ₊ₖ}_{i≤M}.

The parameter λ_{j,k} may be defined as:

λ_{j,k}=softmax({αwᵢ₊ⱼ}_{i≤M})_{j′}

where α is a hyperparameter.

The loss may be defined, for each timestep k of a sequence of timesteps, as lₖ-Σ_{j=M}_{₂}^{M}^{₁}λ_{j,k} d(x_{k+j|k}, oₖ₊ⱼ), in which:
x_{k|k} is an estimated system state of the computed system states at timestep k that may or may not depend on any observation(s) at timestep k+1 or later,
x_{k+j|k} for non-zero j is a past or future predicted system state at timestep k+j that is predicted from the estimated system state x_{k|k},
d(x_{k+j|k}, oₖ₊ⱼ) is the distance measure between the system state x_{k+j|k} and an observation(s) oₖ₊ⱼ of the sequence of observations at timestep k+j,
M₁ is a number of steps into the future greater than or equal to zero, and
M₂ is less than or equal to zero and defines a number of steps into the past;
wherein the system state x_{k+j|k} is computed based on the filter parameters, and λ_{j,k} is a weighting factor that is also dependent on the filter parameters.

Each timestep k may be associated with a filter parameter wₖ of the filter parameters, wherein each predicted system state x_{k+j|k} is computed based on the filter parameter wₖ, and λ_{j,k} is dependent on a subset of the filter parameters {wᵢ₊ₖ}_{M}_{₂}_{≤i≤M}_{₁}.

The parameter λ_{j,k} may be defined as:

λ_{j,k}=softmax({αwᵢ₊ⱼ}_{M}_{₂}_{≤i≤M}_{₁})_{j′}

where α is a hyperparameter.

The loss function may be defined as a uniformly weighed distance measure between the computed system states and the observations, the distance measure weighted independently of the filter parameters.

The loss may be defined, for each timestep k of a sequence of timesteps, as lₖ=1/M Σⱼ₌₀^{M} d(x_{k+j|k}, oₖ₊ⱼ), in which:
d(x_{k+j|k}, oₖ₊ⱼ) is the distance measure between a predicted system state x_{k+j|k} of the computed system states at timestep k+j and an observation(s) oₖ₊ⱼ of the sequence of observations at timestep k+j, the predicted system state x_{k+j|k} computed by the filter, based on the filter parameters, from one or more observations at or prior to, but not later than, timestep k, and
M is a number of lookahead steps greater than or equal to zero.

The loss may be defined, for each timestep k of a sequence of timesteps, as lₖ=1/MΣ_{j=M}_{₂}^{M}^{₁} d(x_{k+j|k},oₖ₊ⱼ), in which:
x_{k|k} is an estimated system state of the computed system states at timestep k that may or may not depend on any observation(s) at timestep k+1 or later,
x_{k+j|k} for non-zero j is a past or future predicted system state at timestep k+j that is predicted from the estimated system state x_{k|k},
d(x_{k+j|k}, oₖ₊ⱼ) is the distance measure between the system state x_{k+j|k} and an observation(s) oₖ₊ⱼ of the sequence of observations at timestep k+j,
M₁ is a number of steps into the future greater than or equal to zero,
M₂ is less than or equal to zero and defines a number of steps into the past, and
M is a constant.

An estimated system state may be computed for each observation oₖ of the sequence of observations, based on a predicted state term depending on observations {o₁, . . . , oₖ₋₁}, and a gain term dependent on at least the observation oₖ, wherein the configurable filter parameters comprise at least a set of weights {wₖ}, each weight applied to scale the gain term for a respective system state.

The filter may be a Kalman filter, wherein the estimated system state \hat{x}_{k|k} for observation oₖ is computed as follows:

x_{k|k}=x_{k|k-1}+wₖKₖ^{o}yₖ,

where X_{k|k-1} is the predicted state term, Kₖ^{o} is the optimal Kalman gain, and yₖ is an innovation mean dependent on observation oₖ.

The filter parameters may comprise at least an initial system state, wherein the initial state is independent of the sequence of observations.

The filter parameters may comprise at least a set of covariance parameters, each covariance parameter representing the covariance of a respective observation.

The filter parameters may comprise at least a set of process noise parameters, each process noise parameter representing process noise at a respective observation, wherein the process noise is random noise present in the transition from a system state at one observation to the system state at the next observation.

The filter may be applied to a sequence of observations obtained using a single sensor.

The filter may be applied to observations obtained using two or more sensors.

The filter may be applied to determine system states relating to a single object of a scene, the scene comprising two or more objects.

The observations may pertain to one or more detected objects, the system states comprising states of the detected objects.

The system states may comprise ego states of an ego system, the observations pertaining to the ego system.

The observations may take the form of perception outputs pertaining to a perceived static or dynamic scene.

The perception outputs may pertain to the detected objects.

The filter may be a smoother.

A second aspect disclosed herein provides one or more processors configured to implement any of the methods taught herein.

A further aspect disclosed herein provides a computer program configured, when executed in a computer system, to cause the computer system to implement any of the methods taught herein.

Such gradient-based optimization techniques are more typically used in deep learning, such as neural network training. By contrast, the present techniques may be applied in the context of “classical” filtering, i.e. with a classical filter that is not a neural network or other “black box” machine learning model, but rather whose filtering logic is algorithmically encoded. In that context, the configurable parameters allow the existing filtering logic of the classical filter to be flexibly “tweaked” to better accommodate outliers in any given sequence of observations. Note, such filtering logic may inherently cause different observations to make different levels of contribution to the state estimate (e.g., as noted, a Kalman filter combines observations in a way that respects their individual levels of uncertainty; observations with relatively higher uncertainty will therefore, by default, make a relatively lower contribution to the state estimates); however, in the present context, this can be controlled to an extent via the configurable filter parameter(s), e.g. by re-weighting outlier observations to reduce their contribution (directly or indirectly).

Another difference between gradient-based optimisation described herein for filtering algorithms and ‘black-box’ deep learning models, is that the optimisation uses knowledge about how the filter works and knowledge of the data to optimise the parameters for that filter and data. The ‘self-supervised’ training of filter parameters to suit the data of the given application makes the filtering method robust to many applications. By contrast, deep learning models to identify outliers would need to be trained on large volumes of data annotated for outliers, and would only be able to generalise well to data similar to that already seen in training.

A particular advantage of using a gradient-based optimisation method to train filters, for example as part of a perception component of an autonomous vehicle stack, arises where other components of the stack are implemented as deep learning models such as deep neural networks, which are also trained using gradient-based optimisation. It is possible in this case to perform ‘end-to-end’ gradient-based training of these parts of the stack, where each component may be trained so as to minimise a loss function which is differentiable with respect to parameters of the stack.

Substantially optimal values of the filtering parameters are “learned” in the gradient-based optimization of the loss function. However, the aim of the present gradient-based optimization is not necessarily “generalized” learning that can then be applied to other data; for example, it may be that the learned filtering parameters are specific to the sequence of observations from which they are learned, and cannot be readily applied to different sequences of observations; rather, the optimal filtering parameters are learned from the observations being filtered, in order to improve the robustness of the state estimates derived from those same observations.

### BRIEF DESCRIPTION OF FIGURES

For a better understanding of the present disclosure, and to show how embodiments of the same may be carried into effect, reference is made by way of example only to the following figures, in which:

FIG. 1 shows an example runtime stack for an autonomous vehicle;

FIG. 2 shows an example of a weighted Kalman filter applied to a time sequence of observations;

FIG. 3 shows an illustrative example of gradient-based updates of weights of a Kalman filter.

### DETAILED DESCRIPTION

Described herein is a method for estimating a ground truth state of a system using Kalman filters, where the updated state estimated by the filter at each time step is calculated using parameters associated to each observation. Gradient descent methods are used to determine an optimal contribution of observations, with the optimal parameters minimising a loss function defined to penalise deviations between states of the filter and observations, with deviations for outlying observations being penalised to a lesser degree than deviations for inlying observations. This provides an improvement over existing gating mechanisms used to distinguish inliers from outliers, as it learns an optimal classification of observations into inliers and outliers while iteratively improving the state estimates generated by the filter. This does not require the filter to have stabilised. Note that ‘outliers’ as used herein is a relative term to denote observations that diverge from the expected set of states of the system. The classification of observations described herein is a ‘soft’ classification, as observations are not required to be labelled absolutely as either inliers or outliers, rather parameters are learned that represent a relative degree to which each observation is an outlier.

These methods may be used, for example, in an offline perception system for autonomous vehicles (or sensor-equipped vehicles more generally), in order to determine tracks for stationary or moving objects in a scene given a set of observations from a camera and/or other sensors.

For the sake of illustration, the techniques are described in the context of filtering observations captured by sensor-equipped vehicles. It will be appreciated that the described techniques can be applied more generally in any context in which noisy measurements are combined through filtering, including but not limited to other areas of robotics.

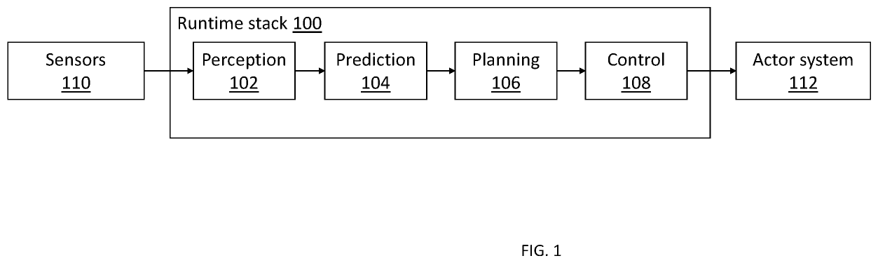

FIG. 1 shows a highly schematic block diagram of a runtime stack 100 for an autonomous vehicle (AV), also referred to herein as an ego vehicle (EV). The run time stack 100 is shown to comprise a perception system 102, a prediction system 104, a planner 106 and a controller 108.

In a real-world context, the perception system 102 would receive sensor inputs from an onboard sensor system 110 of the AV and uses those sensor inputs to detect external agents and measure their physical state, such as their position, velocity, acceleration etc. The onboard sensor system 110 can take different forms but generally comprises a variety of sensors such as image capture devices (cameras/optical sensors), lidar and/or radar unit(s), satellite-positioning sensor(s) (GPS etc.), motion sensor(s) (accelerometers, gyroscopes etc.) etc., which collectively provide rich sensor data from which it is possible to extract detailed information about the surrounding environment and the state of the AV and any external actors (vehicles, pedestrians, cyclists etc.) within that environment. The sensor inputs typically comprise sensor data of multiple sensor modalities such as stereo images from one or more stereo optical sensors, lidar, radar etc.

The perception system 102 comprises multiple perception components which co-operate to interpret the sensor inputs and thereby provide perception outputs to the prediction system 104. External agents may be detected and represented probabilistically in a way that reflects the level of uncertainty in their perception within the perception system 102.

The perception outputs from the perception system 102 are used by the prediction system 104 to predict future behaviour of external actors (agents), such as other vehicles in the vicinity of the AV. Other agents are dynamic obstacles from the perceptive of the EV. The outputs of the prediction system 104 may, for example, take the form of a set of predicted obstacle trajectories.

Predictions computed by the prediction system 104 are provided to the planner 106, which uses the predictions to make autonomous driving decisions to be executed by the AV in a given driving scenario. A scenario is represented as a set of scenario description parameters used by the planner 106. A typical scenario would define a drivable area and would also capture any static obstacles as well as predicted movements of any external agents within the drivable area.

The present disclosure relates to a method of generating an estimated ‘ground-truth’ state for a dynamical system given a series of noisy observations of the system. This may be used, for example, in a perception system 102, to generate perception outputs identifying the trace of objects or agents of a scene given a set of sensor inputs from an onboard sensor system 110. The perception component may be ‘offline’, wherein it is not held on the autonomous vehicle stack.

The method disclosed herein uses a configurable filter to determine estimated states of a system given a set of observations. Note that the terms ‘filter’ and ‘filtering’ are used herein to refer to estimation methods which use historical data only as well as estimation methods using historical and future data (also known as ‘smoothing’). Note that the techniques described herein may be applied to different types of filters, including smoothers. One example of a suitable filter is a Kalman filter. In a standard Kalman filter, the system is modelled as a series of states where each state is estimated as a state transition model applied to a previous state, with Gaussian noise (‘process noise’) added. Observations of the state, for example measurements from sensors, are modelled as an observation model applied to the estimated state with Gaussian noise added (‘observation noise’).

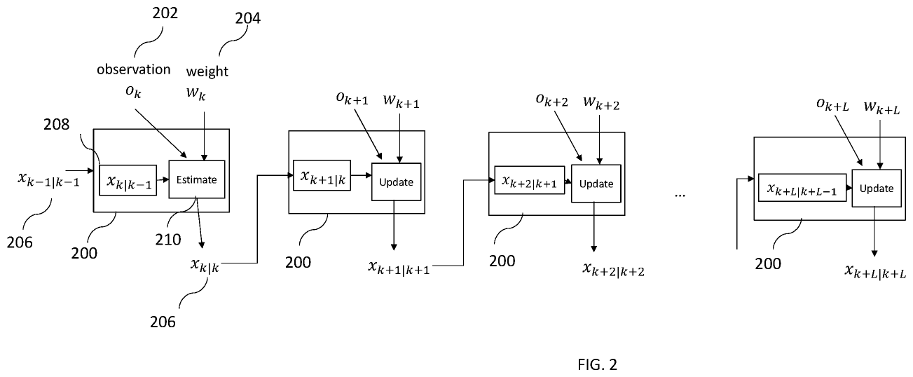

FIG. 2 shows an illustrative example of the update of the state of the system over a time series of observations [o₁, . . . oₙ] using a standard Kalman filter 200. Note that at each state, the filter 200 estimates both a state x of the system and a covariance P (or uncertainty) for the state estimate x. However, for simplicity, FIG. 2 shows only the update of the estimated state x. At a given step k, the state estimate x_{k-1|k-1} and the covariance P_{k-1|k-1} generated by the filter 200 for the previous step is received.

At a predict step, a predicted state x_{k|k-1} and predicted covariance P_{k|k-1} are determined based on the received estimated state and covariance (x_{k-1|k-1}, P_{k-1|k-1}). In the case of a standard Kalman filter, the notation x_{k|m} refers to a predicted state at step k, given observations only up to step m. The example shown in FIG. 2 generates a predicted state 208 for the current time step given observations 202 and states 206 up to the previous step, before the current observation oₖ is received.

Kalman filters assume that the underlying state of a dynamic system can be estimated from a series of noisy observations. In a simple example, for a system with no control inputs, the ‘ground-truth’ state at each time step is assumed to be determined by applying a state transition model to the ground-truth state at the previous step and adding noise. This can be represented by the following equation:

xₖ=ƒ(xₖ₋₁)+vₖ (1)

where ƒ is a state transition function and vₖ is the process noise.

The predicted state 208 and covariance is calculated based on the dynamics of the system, i.e. the state transition function ƒ applied to the earlier estimated state, in this case x_{k-1|k-1}.

Different variations of Kalman filters may be used based on assumptions about the underlying system dynamics. The standard Kalman filter assumes that the underlying state transition function is linear. However, for non-linear systems, an extended Kalman filter (EKF) or unscented Kalman filter (UKF) may be used. The UKF determines a predicted state based on a random sampling of points (‘sigma points’) around the mean, using the unscented transformation, where the sampled points are propagated through the nonlinear transition and observation functions ƒ and h to determine a new mean and covariance at each step. Note that the methods described herein for determining configurable parameters of the filter to minimise the contribution of outliers may be applied to any suitable filtering method. The state of the system may be initialised to some initial state x₀ at a first time step. This is the state of the system before any observations are known. For each subsequent time step, a predicted state and covariance is determined, given the observations and states up to the previous time step.

As mentioned above, smoothers use both previous and future observations in order to estimate a state. One example smoothing algorithm, called the Rauch-Tung-Striebel (RTS) smoother uses a forward pass comprising a regular Kalman filter to compute filtered state estimates and a backward pass to compute smoothed state estimates. The techniques described herein may be applied to this and other smoothing algorithms.

As shown in FIG. 2, at time step k, the filter 200 receives the observation 202 of the system for the current time step. A new estimated state 206 for the current time step (x_{k|k}) may be determined based on the Kalman filter update rules. An unscented Kalman filter uses the following rule to determine an estimated state and covariance from the given predicted state and covariance (x_{k|k-1}, P_{k|k-1}):

x_{k|k}=x_{k|k-1}+Kₖyₖ (2)

P_{k|k}=P_{k|k-1}−KₖCₖ^{T}−CₖKₖ^{T}+KₖSₖKₖ^{T} (3)

where Kₖ is the Kalman gain, and yₖ, Sₖ and Cₖ are the innovation mean, innovation covariance and cross-covariance between the state and the projection to the observation space, where ‘innovation’ refers to the residual between the observation and the projected state prediction in observation space. The above update equations are obtained by propagating the sampled points around the mean through both the state transition function ƒ and the observation function h. While FIG. 2 only shows a predicted state estimated for the next consecutive timestep, i.e. x_{k|k-1}, the state transition function may be applied multiple times to obtain predicted states j steps in the future based on observations up to the current timestep k, i.e. x_{k+j|k}.

The present disclosure provides a configuration of parameters of the above update rule that treats the contributions of inlying and outlying observations differently in the update to the system state. There are multiple choices of parameters to configure in the Kalman update. One possibility is to introduce a weight wₖ ∈[0,1] associated with each observation, and re-scale the Kalman gain in the equation above by wₖ:

Kₖ=wₖKₖ^{o}, (4)

where Kₖ^{o} is the optimal Kalman gain, which depends on the predicted covariance and the observation model. The update step then comprises:

x_{k|k}=x_{k|k-1}+wₖKₖ^{o}yₖ. (5)

Then, for a given observation at time k, if the corresponding weight wₖ=0, the observation will be treated as an outlier and ignored in the update, leaving the state unchanged, while if wₖ=1, a normal optimal Kalman update is applied to the state.

As shown in FIG. 2, once the weight and observation wₖ, oₖ are received, the estimated state is updated and output by the Kalman filter. It is also passed back into the Kalman filter to generate the next predicted state and covariance values (x_{k+1|k}, P_{k+1|k}) and repeat the update step given the next weight wₖ₊₁ and observation oₖ₊₁ in an iterative process.

Note that, while the above example refers to a single weight applied to the optimal Kalman gain, the weight providing a measure of the degree to which the given observation is an inlier or an outlier, other parameters may be used in the Kalman filter to provide improved robustness to outliers. Other possible parameters which may be optimised according to the methods herein are described in more detail later.

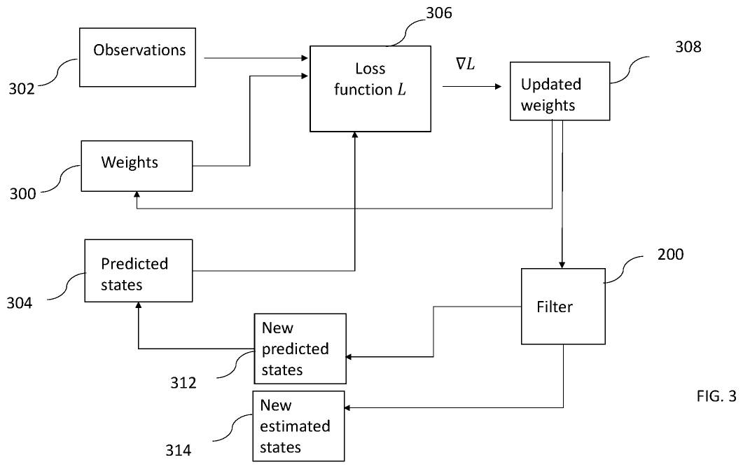

For a given set of observations of a nonlinear system, it is not known which observations are inliers and which are outliers if the ground truth state of the system is unknown. There is thus no ‘ground truth’ set of weights to be applied to observations. A method to optimise the weights of the Kalman update in order to generate the best set of states is described below with reference to FIG. 3.

FIG. 3 shows the iterative process of updating the weights of the Kalman update, starting with an initial set of weights 300, a set of observations 302 of the system and the predicted states 304 generated by the Kalman filter 200 at each observed time step k. Gradient-based optimisation of a loss function is carried out to generate an optimal set of weights.

As shown in FIG. 3, at each step of the iterative optimisation, the observations of the system 302, the current set of weights 300, and the set of predictions 304 generated by the Kalman filter 200 are used to compute a loss function 306. In the present example, the loss function 306 is defined to penalise deviations of the predicted states from the observations of the system at the corresponding time-step, with weights applied so as to reduce the contribution of outlying observations to the loss and prevent the filter from estimating an underlying system state that is based on outlying observations.

An example of a suitable loss function is defined for each state of the system as:

lₖ=Σⱼ₌₀^{M}λ_{j,k}d(x_{k+j|k},oₖ₊ⱼ), (6)

with the overall loss function for the set of observations (0, . . . , N) as:

$$L ( w ) = \frac{1}{N} {\sum }_{k = 1}^{N} {l}_{k} . \qquad ( 7 )$$

This ‘self-supervised’ loss function uses predicted states that are determined for a set of steps to look forward in the future, where in the above, M is the number of look ahead steps. The loss function evaluates, for a given state, how good the predicted states are for each number of steps into the future up to M, essentially determining how good the given state xₖ is at predicting future observations. d(x_{k+j|k}, oₖ₊ⱼ) is a distance measure between the predicted state and the observation at that future timestep, and λ_{j,k} are loss re-weighting parameters. An example distance function may be defined as follows:

d(xⱼ,oⱼ)=|proj(xⱼ)−oⱼ| (8)

where proj(xⱼ) is the projection of the system state xⱼ into the space of observations, i.e. where a state comprises a position and velocity of a given object, an observation may comprise just the object's position, and the projection in this case would be the components of the state defining its position.

The above distance metric, sometimes referred to as ‘L1 distance’ leads to improved robustness of the loss function to outliers than, for example, L2 distance, which is based on a sum of square distances, and which therefore has a stronger dependency on large distances for outliers.

In some embodiments, the loss function may apply uniform loss re-weighting parameters. In this case, the loss function lₖ for each observation may, for example, be written:

$${l}_{k} = \frac{1}{M + 1} {\sum }_{j = 0}^{M} d ( {x}_{k + j \vert k} , {o}_{k + j} ) , \qquad ( 9 )$$

where the distance function is defined as above.

In this case, weights are learned which minimise the total distance between the predicted states and the corresponding observations in the ‘look-ahead’ window of timesteps. The distance function between predicted states and their corresponding observations depends on the weights applied to determine the current state.

In general, the predicted states for a given estimated state x_{k|k} are more predictive of future observations if the current estimated state x_{k|k} is a good estimate of the real underlying state. The distance function will be minimised when the Kalman update weights more heavily those observations which are representative of the underlying state of the system. This therefore tends to an assignment of weights in which observations that are representative of the underlying state contribute more to the Kalman update than observations that are caused by an external noise distribution or some other effect rather than the dynamics of the system, i.e. ‘outliers’. However, since this loss function applies an equal weight to all predicted states, this learning rule relies on the observations on average being representative of the underlying state. Therefore, the performance of this learning algorithm degrades whenever there is a very high percentage of observations caused by effects outside of the state dynamics (i.e. a high percentage of outlier observations), for example above 30% outliers. This is because the distance function no longer represents a reasonable measure of the ability to predict the state of the system, and instead incentivises both of the competing goals of predicting noisy ‘outlier’ observations and predicting state dynamics.

However, the loss re-weighting parameters λ_{j,k} may be defined such that the loss function weights the distance function d(x_{k+j|k}, oₖ₊ⱼ), depending on the weighting of the observations oₖ₊ⱼ as ‘inliers’ or ‘outliers’, placing more importance on the ability to predict observations classed as inliers than those classed as outliers.

An example weight-dependent definition re-weighting parameter may be defined as follows:

λ_{j,k}=softmax({αwᵢ₊ₖ}_{i≤M})ⱼ, (10)

where α is a temperature parameter which is a constant hyperparameter and the value of α may be pre-set.

The above set of re-weighting parameters depend on the weights wⱼ such that inliers have a larger contribution to the loss function than outliers.

The loss function of Equation 6 (and the simpler loss function of Equation 9) takes the estimated state x_{k|k} (computed from observations up to time k only), and only looks forward in time: weighting states x_{k+j|k} forecasted into the future according to how well they match subsequent observations in time.

One way to generalize the loss function is to make the loss function look backwards in time as well, i.e. weighting states x_{k-j|k} predicted (forecasted) back in time via some reversible motion/transition model according to how well they match past observations. For example, there are various Kalman smoothing methods that are reversible in this sense (e.g. Rauch-Tung-Striebel, Modified Bryson-Frazier smoother, Minimum-variance smoother etc.)

Another way to generalize the loss function is to use some smoothing method (e.g. forwards-backwards smoothing) to make the estimated state x_{k|k} itself dependent on future observations (k+1 . . . ), as well as past observations. In this example, the predicted state x_{k+j|k} is predicted from the smoothed state x_{k|k}. For the avoidance of doubt, in the most general case, the notation x_{k|k} simply means the filter's estimate of the system state at time k, which could be based on observations at k+1 or later (e.g. if x_{k|k} is a smoothed state); the notation x_{k+j|k} means, in the case of non-zero j, some past (negative j) or future (positive j) state predicted from the estimated state x_{k|k} via some reversible or forward state transition/motion model.

One or both of the above extensions can be used in a smoothing context.

A more general form of the loss function is, therefore:

lₖ=Σ_{j=M}_{₂}^{M}^{₁}λ_{j,k}d(x_{k+j|k},oₖ₊ⱼ), (11)

in which M₂ may be less than zero and/or the estimated system state x_{k|k} may have some dependence on observations at k+1 or later (e.g. as a consequence of smoothing). In general, the interval [M₂, M₁] is some suitable prediction window. In the case that M₁=M₂=0, the loss function only considers the deviation between the estimated state x_{k|k} and the observation(s) oₖ. For forward filtering, M₂=0, and for backwards filtering M₂ is non-zero and negative (defining a number of steps into the past). The condition “i≤M” above becomes “M₂≤i≤M₁”. The simpler loss function can be similarly generalized (in this case, M is some constant, such as the total number of steps that is summed over).

The above loss function 306 may be referred to as a ‘self-supervised’ loss function, as it does not use labelled data, i.e. the loss function encourages the Kalman filter to estimate a more accurate ground state of the system without any knowledge of the ground state, only the noisy observations which are used as input to the filter. The loss re-weighting parameters use the weight assignments of previous iterations of learning in order to determine the contribution of the observations to the loss function in future iterations, such that as the algorithm becomes more confident about particular observations being outliers, the less these observations contribute to the Kalman updates, and the less these observations contribute to future loss functions.

‘Re-injecting’ the learned weights to the re-weighting parameters in this way has the effect of making the filter robust to even larger numbers of outlying observations, for example in cases where more than 50% of observations are ‘outliers’, i.e. not generated by the underlying state dynamics. This is because during learning, an assignment of at least some of the outlying observations as close to zero feeds back into the loss function such that the system focuses on the remaining observations, meaning that the loss function focuses on observations that comprise a larger contribution from ‘inliers’ at each iteration. The optimal weighting determines an update of the Kalman filter at each timestep such that the states generated are predictive of the inlying observations of the system, rather than predictive of the observations overall (which may be caused more by noise than system dynamics in some cases).

For example, assuming all weights are initially set to a uniform initial value, such that all observations are considered equally likely to be outliers, and the Kalman update at each state determines an estimate using the optimal Kalman gain, taking each observation into account. When the loss function is determined for this set of states, the re-weighting parameter is constant, and the loss function depends only on the distance between the predicted states of the filter and the observations. The distance between predicted states and observations is highest for outliers, and thus the weight update will lead to a lower weighting on the outlying observations. Note that an appropriate normalisation is applied to the weights at each training iteration such that they are constrained to the range [0,1]. The iterative update process continues, where at each iteration, outlying observations contribute the most to the loss function and their weights are updated until they are low enough that the re-weighting parameters λ_{j,k} sufficiently scale down their contribution to the loss.

At each iterative step of the optimisation, the observations, weights, and predicted states are used to compute an estimated gradient of a loss function L with respect to the current weights of the system. A stochastic gradient descent scheme may be used to optimise the loss function L, wherein a random subset of observations is determined at each iteration, based on which the estimated gradient is computed. For stochastic gradient descent, the observations 302 passed to the loss function 306 comprise a random subset of the observations 1, . . . , N observed for the system in total.

An updated set of weights is generated by adjusting the current weights in the direction of the negative gradient of the loss function. The updated weights 308 are passed to the filter 200 and used to generate new estimated states at each time step according to the update rule given above (Eq. 5). The filter 200 generates new predicted states 312 and estimated states 310, with the new predicted states for each state being computed for each number of steps in the future up to the predefined number of steps to look forward or backward. The observations, new weights 308 and new predicted states 312 are used as input to the next iteration of the loss function.

A threshold or stopping criteria may be defined to determine when an optimal set of weights have been reached. An example stopping criterion may be when the loss function falls below a specified threshold, meaning in the above example that the predicted states generated by the filter are sufficiently close to the observations as a whole. Another possible stopping criterion is defined by the weight updates falling below a specified threshold, i.e. the difference between weights from one iteration to the next has become sufficiently small that they are considered to have converged to a final set of weights.

Note that the parameters of the Kalman filter are not ‘trained’ in the sense that they are tuned for general use on future data, and the above optimisation of the loss function would not be considered training in the same way as, for example, training of neural networks by minimising a loss function. In other words, whilst the weights are learned, they do not necessarily encode generalized knowledge that can be applied to other data. The weights of the Kalman filter are associated directly with the observations of the system, and the process of optimising the loss function is intended to find optimal data for that set of observations.

The gradient-based optimisation described above may be applied to a Kalman filter in either an online or an offline context. For online learning, in which optimisation is applied while observations are being received, the optimisation may be applied only up to the most recent observation. In this case, the full optimisation is carried out for a particular window of the system state, for example a set of 100 observations, and only the weights corresponding to these observations are updated. The loss function for the online learning is given by equation 7 above, where N in this case refers to the chosen size of the observation window on which to apply the optimisation. In contrast, for offline learning, the optimisation is applied to the full set of observations.

Note that, while the above description refers to Kalman filters, observations may also be processed by a Kalman smoother which carries out the update steps of the Kalman filter along the sequence of observations in a ‘forward pass’, and computes smoothed estimate states and covariances in a backwards bass, based on the full set of predicted and estimated states and covariances generated in the forward pass. There are multiple types of Kalman smoothers that are known in the art which may be applied, one example of which is the Rauch-Tung-Striebel (RTS) smoother. Parameters of the Kalman smoother may be configured to handle outliers according to the gradient-based methods described herein.

As well as optimising weights applied to the Kalman gain, a number of other parameters of the filter update may be configured to improve the robustness of state estimates to outliers. For example, the covariance of the observations may be optimised in a similar way in order to tune the certainty of each observation in order to weight their contributions where an observation with higher certainty (i.e. lower covariance) contributes more to the estimate of the state by the filter. Similarly, the process noise at each observation may be associated with a weight that may be optimised. The initial state of the filter may also be optimised in this way.

The above techniques may be used to optimise Kalman filters or similar filters for use in a range of applications. While the above description refers mainly to an implementation of Kalman filter to estimate a single system state over time based on observations of the system, the principles may be extended to other applications, such as multiple sensor fusion, in which the state of a system is updated based on observations from multiple filters, and multi-object tracking, in which object detections are tracked over time based on observations of a scene.

For multiple sensors, the optimisation may be carried out in the same way as described above, where outlier observations must be filtered for observations captured by more than one sensor. For multi-object tracking, the same principles may be used to improve association accuracy for associating observations to particular objects of a scene. In this case, the loss function would penalise contributions of observations to the state updates for a given object if the observations are ‘outliers’ for the underlying dynamics for that object.

In the context of sensor-equipped vehicles and the like, filters have various applications. One application is the tracking of (external) detected objects, such as vehicles, pedestrians, cyclists, animals, road structure, road signage etc. In this context, the observations may, for example, take the form of perception outputs, such as detected bounding boxes, object locations, object poses etc. Such perception outputs can be derived from sensor data (of one or multiple modalities) using a variety of perception components, such as trained CNNs etc. for perceiving objects in static or dynamic scenes. Another application is the tracking of an ego state, such as the state of a sensor equipped vehicle (the ego vehicle) to which the observations pertain. For example, an ego localization method may be used on a vehicle (or other ego system) to allow the vehicle to estimate its own location. In that context, the observations could, for example, be obtained via odometry applied to IMU (inertial measurement unit), visual odometry based on imaging or lidar, satellite positioning etc. In either case, the present filtering can be applied to compute detected object states or ego states that are robust to outlier observations. In a real-world context, such observations may be derived from real sensor data. In a simulation/testing context, such observations may be derived in the same way but from synthetic sensor data, generated using appropriate sensor models, or derived directly from a simulated scenario without the use of sensor models or synthetic sensor data. In a simulation context, the perceived scene is a simulated scene from which the perception outputs are directly or indirectly generated.

As described above, the techniques described above may be applied to the output of a perception system 102 of an autonomous vehicle stack, shown in FIG. 1. The perception system receives data from one or more sensors of the autonomous vehicle. Perception outputs from the perception system 102 convey extracted information about structure exhibited in the sensor data. Sensor data may for example comprise images, inertial sensor data, or 3D lidar/radar point clouds. Examples of perception outputs include 2D or 3D bounding boxes, object locations/orientations, object/scene classification results, segmentation results etc. The perception outputs can then be used for application-specific processing.

The sensor data can be received and processed in real-time or non-real time by a perception system to generate perception outputs. The perception system 102 may be an onboard perception system of the ego vehicle that processes the sensor data in real time to provide perception outputs (such as 2D or 3D object detections) to motion planning/prediction etc. Alternatively, the processing system may be an offline system that does not necessarily receive or process data in real time. For example, the perception system 102 could process batches of sensor data in order to provide semi/fully automatic annotation (e.g., for the purpose of training, or extracting scenarios to run in simulation), mapping etc.

The present techniques can also be applied to synthetic sensor data. For example, increasingly simulation is used for the purpose of testing autonomous vehicle components. In that context, components may be tested with sensor-realistic data generated using appropriate sensor models. Note that references herein to data being “captured” in a certain way and the like encompass synthetic data which have been synthesised using sensor model(s) to exhibit substantially the same effects as real sensor data captured in that way.

The techniques herein can also be applied to perception outputs which have been simulated directly, without generating synthetic sensor data to be processed by the processing system.

References herein to components, functions, modules and the like, denote functional components of a computer system which may be implemented at the hardware level in various ways. This includes the components depicted in FIGS. 1, which may be implemented by a suitably configured computer system. A computer system comprises one or more computers that may be programmable or non-programmable. A computer comprises one or more processors which carry out the functionality of the aforementioned functional components. A processor can take the form of a general-purpose processor such as a CPU (Central Processing unit) or accelerator (e.g. GPU) etc. or more specialized form of hardware processor such as an FPGA (Field Programmable Gate Array) or ASIC (Application-Specific Integrated Circuit). That is, a processor may be programmable (e.g. an instruction-based general-purpose processor, FPGA etc.) or non-programmable (e.g. an ASIC). Such a computer system may be implemented in an onboard or offboard context.

References may be made to ML perception models, such as CNNs or other neural networks trained to perform perception tasks. This terminology refers to a component (software, hardware, or any combination thereof) configured to implement ML perception techniques. In general, the perception system 102 can be any component configured to recognise object patterns in the sensor data. The above considers a bounding box detector, but this is merely one example of a type of perception component that may be implemented by the perception system 102. Examples of perception methods include object or scene classification, orientation or position detection (with or without box detection or extent detection more generally), instance segmentation etc. For an ML object detector, the ability to recognize certain patterns in the sensor data is typically learned in training from a suitable training set of annotated examples.

1. A computer-implemented method of filtering noisy observations of a system to estimate a state of the system, the method comprising:
applying a filter to a sequence of observations based on one or more filter parameters, to compute a set of system states, the filter parameters configurable to change respective contributions of the observations to the set of system states;
wherein the filter is applied in multiple iterations with different values of the configurable filter parameter(s), to update the set of system states, wherein the different values of the configurable filter parameter are determined via a gradient-based optimization of a loss function that penalizes values of the configurable parameters that result in relatively large contributions from outlier observations that deviate from the set of system states by a relatively large amount.

2. The method of claim 1, wherein the loss function is defined as a weighted distance measure between the computed system states and the observations, the distance measure weighted in dependence on the filter parameters.

3. The method of claim 2, wherein the loss function is defined, for each timestep k of a sequence of timesteps, as lₖ=Σ_{j=M}_{₂}^{M}^{₁}λ_{j,k} d(x_{k+j|k}, oₖ+j), in which:
x_{k|k} is an estimated system state of the computed system states at timestep k that may or may not depend on any observation(s) at timestep k+1 or later,
x_{k+j|k} for non-zero j is a past or future predicted system state at timestep k+j that is predicted from the estimated system state x_{k|k},
d(x_{k+j|k}, oₖ₊ⱼ) is the distance measure between the system state x_{k+j|k} and an observation(s) oₖ₊ⱼ of the sequence of observations at timestep k+j,
M₁ is a number of steps into the future greater than or equal to zero, and
M₂ is less than or equal to zero and defines a number of steps into the past;
wherein the system state x_{k+j|k} is computed based on the filter parameters, and λ_{j,k} is a weighting factor that is also dependent on the filter parameters.

4. The method of claim 3, wherein each timestep k is associated with a filter parameter wₖ of the filter parameters, each system state x_{k+j|k} is computed based on the filter parameter wₖ, and λ_{j,k} is dependent on a subset of the filter weights {wᵢ₊ₖ}_{M}_{₂}_{≤i≤M}_{₁}.

5. The method of claim 4, wherein
λ_{j,k}=softmax({αwᵢ₊ₖ}_{M}_{₂}_{≤i≤M}₁)j′
wherein α is a hyperparameter.

6. The method of claim 1, wherein the loss function is defined as a uniformly weighed distance measure between the computed system states and the observations, the distance measure weighted independently of the filter parameters.

7. The method of claim 6, wherein the loss function is defined, for each timestep k of a sequence of timesteps, as lₖ=1/M Σ_{j=M}_{₂}^{M}^{₁}d(x_{k+j|k}, oₖ₊ⱼ), in which:
x_{k|k} is an estimated system state of the computed system states at timestep k that may or may not depend on any observation(s) at timestep k+1 or later,
x_{k+j|k} for non-zero j is a past or future predicted system state at timestep k+j that is predicted from the estimated system state x_{k|k},
d(x_{k+j|k}, oₖ₊ⱼ) is the distance measure between the system state x_{k+j|k} and an observation(s) oₖ₊ⱼ of the sequence of observations at timestep k+j,
M₁ is a number of steps into the future greater than or equal to zero,
M₂ is less than or equal to zero and defines a number of steps into the past, and
M is a constant.

8. The method of claim 1 wherein an estimated system state is computed for each observation oₖ of the sequence of observations, based on a predicted state term depending on observations {o₁, . . . , oₖ₋₁}, and a gain term dependent on at least the observation oₖ, and wherein the configurable filter parameters comprise at least a set of weights {wₖ}, each weight applied to scale the gain term for a respective system state.

9. The method of claim 8, wherein the filter is a Kalman filter, and wherein the estimated system state x_{k|k} for observation oₖ is computed as follows:
x_{k|k}=x_{k|k-1}+wₖKₖyₖ,
wherein x_{k|k-1} is the predicted state term, Kₖ^{o} is the optimal Kalman gain, and yₖ is an innovation mean dependent on observation oₖ.

10. The method of claim 1, wherein the filter parameters comprise at least an initial system state, wherein the initial state is independent of the sequence of observations.

11. The method of claim 1, wherein the filter parameters comprise at least a set of covariance parameters, each covariance parameter representing the covariance of a respective observation.

12. The method of claim 1, wherein the filter parameters comprise at least a set of process noise parameters, each process noise parameter representing process noise at a respective observation, wherein the process noise is the random noise in the transition from a system state at one observation to the system state at the next observation.

13. The method of claim 1, wherein the filter is applied to a sequence of observations received from a single sensor.

14. The method of claim 1, wherein the filter is applied to observations received from two or more sensors.

15. The method of claim 1, wherein the filter is applied to determine system states relating to a single object of a scene, the scene comprising two or more objects.

16. The method of claim 1, wherein the observations pertain to one or more detected objects, the system states comprising states of the detected objects.

17. The method of claim 1, wherein the system states comprise ego states of an ego system, the observations pertaining to the ego system.

18. The method of claim 16, wherein the observations take the form of perception outputs pertaining to a perceived static or dynamic scene, and wherein the perception outputs pertain to the detected objects.

19.-20. (canceled)

21. A computer system comprising memory holding computer-executable instructions and one or more processors, wherein the instructions are configured, when executed by the one or more processors, to apply a filter to a sequence of observations based on one or more filter parameters, to compute a set of system states, the filter parameters configurable to change respective contributions of the observations to the set of system states;
wherein the filter is applied in multiple iterations with different values of the configurable parameter(s), to update the set of system states, wherein the different values of the configurable filter parameter are determined via a gradient-based optimization of a loss function that penalizes values of the configurable parameters that result in relatively large contributions from outlier observations that deviate from the set of system states by a relatively large amount.

22. A computer program configured, when executed in a computer system, to cause the computer system to apply a filter to a sequence of observations based on one or more filter parameters, to compute a set of system states, the filter parameters configurable to change respective contributions of the observations to the set of system states:
wherein the filter is applied in multiple iterations with different values of the configurable parameter(s), to update the set of system states, wherein the different values of the configurable filter parameter are determined via a gradient-based optimization of a loss function that penalizes values of the configurable parameters that result in relatively large contributions from outlier observations that deviate from the set of system states by a relatively large amount.
